(19) United States
(12) Patent Application Publication
(10) Pub. No.: US 2020/0285665 A1
(43) Pub. Date: Sep. 10, 2020

(54) System and Methods for Enhancing a Printed Graphic Novel, Book, and e-Book

(71) Applicants: Steven Bress, Germantown, MD (US); Daniel Bress, Germantown, MD (US); James Edward Dunstan, Fredericksburg, VA (US); Mark Bernard Jacobs, Fairfax Station, VA (US)

(72) Inventors: Steven Bress, Germantown, MD (US); Daniel Bress, Germantown, MD (US); James Edward Dunstan, Fredericksburg, VA (US); Mark Bernard Jacobs, Fairfax Station, VA (US)

(21) Appl. No.: 16/810,848

(22) Filed: Mar. 6, 2020

Related U.S. Application Data
(60) Provisional application No. 62/815,356, filed on Mar. 8, 2019.

(51) Int. Cl. G06F 16/435; G06F 3/01; G06F 16/438

(52) U.S. Cl. CPC G06F 16/436; G06K 2009/4657; G06F 16/438; G06F 3/013

(57) ABSTRACT

Enhancing the experience of a user reading a book or e-book by playing content, including, but not limited to; audio, lighting, smell, temperature, air currents, motion, and haptic effects, alone or in any combination, thus creating an environmental immersive experience for the user. Predetermined content is played on one or more playback devices when a user is reading a predetermined area of the printed book, or e-book. The user may select a subset of available playback devices to utilize for a reading session.

### FIELD OF INVENTION

The present invention relates generally to printed graphic novels, books, and electronic books, and, in particular, to enhancing a user's experience of reading by creating an environmentally immersive experience.

### BACKGROUND

Some users prefer printed books to electronic books (e-books). In particular, art books and printed graphic novels may use a color palette not available to be displayed by e-book readers. There is currently no method known in the art to synchronize where in a printed book a user is reading and a method to enhance the reading experience of a printed book by playing predetermined content, such as, but not limited to, audio, visual, smell, and haptic effects. See below for definitions of “content” and “playback content”.

Currently there is no method known in the art to synchronize where in an e-book a user is reading when using a dedicated e-book reader in real time, and a method to enhance the reading experience by playing predetermined content. U.S. Patent application No. 61/675,435 entitled “Application for Synchronizing e-books with original or custom-created scores” (hereinafter called '435) teaches: an e-book reader which can display a visual e-book while playing audio, which a dedicated e-book reader, such as the Amazon Kindle, cannot do. In general, '435 is directed at devices that can read an e-book and have access to a network, such as the internet. For users that prefer to use a dedicated e-book reader, '435 offers no advantages.

The book industry is highly competitive. There is a benefit to making printed books and e-books more competitive by adding the ability to create an environmentally immersive experience. Therefore, there is a need in the art for systems and methods to enhance a printed book or e-book.

### SUMMARY

A new type of book, referred to as a “living book” or “L-Book,” has been invented. The L-Book system promotes Environmental Immersion when reading a book.

In general the L-Book is directed at means to identify where in a book a user is reading. When a user is reading a pre-determined location in a book, means to play pre-determined content on predetermined playback devices. Wherein the pre-determined content may include, but is not limited to, audio, environmental lighting, smell, temperature, air currents, motion and haptic effects; alone or in any combination.

More specifically the preferred embodiment of the current invention is directed toward indicia in a book and towards printed logic and circuitry to:

a. determine what book a user is reading,

b. determine approximately where in a book a user is reading,

c. determine what pre-determined content is to be played at pre-determined areas of a book,

d. determine what devices a user desires the L-Book to use,

e. activate the devices to play the pre-determined content.

a. Determine What Book a User is Reading

In one embodiment a user may simply type the name of the current book the user is reading into an L-Book application (app).

In another embodiment the logic and circuitry of the L-Book scans the current printed book to determine the book title, for example, scanning a QR code on a printed book cover.

In another embodiment, an active tag such as a Radio-frequency identification (RFID) tag is embedded in a printed book, and logic and circuitry is used to read the tag.

b. Determine Approximately where in a Printed Book a User is Reading

A variety of different methods to determine where in the book a user is reading are taught by, but not limited to, the following embodiments. Each embodiment differs in price point, accuracy, and ease of use.

### Indicia in Text

In one embodiment, one or more visual alerts, such as, codes, tags or indicia indicating user action is desired are printed in a book at locations where predetermined content is to be played.

In a further embodiment, these indicia are machine readable, such as QR.

In a further embodiment, these indicia are printed in a color not visible to the human eye, such as Ultra-Violet “UV”.

### Visual Indicia

In one embodiment, when a user sees an indicium, the user is directed to take an action, thereby notifying the current invention an indicium has been seen. When receiving this user input, the current invention plays pre-determined content.

In a further embodiment, the user may be directed toward activating a switch in the cover of a printed book.

In a further embodiment, the switch may be in a removable cover, or book jacket. Thus the cover could be used for multiple, different printed books.

In a further embodiment, the switch may be in a bookmark.

In a further embodiment, the switch may be in wearable clothes, including but not limited to a sweater, slippers, a wristband, jewelry, or a tie.

In a further embodiment, the switch may be a tattoo.

In a further embodiment, the switch may be in, or attached to eyeglasses.

In a further embodiment, the switch may be digital, such as on a mobile device.

In a further embodiment, the action taken is reading the indicium aloud. The indicium is a code which is meant to be spoken aloud, which is then interpreted by a virtual assistant, also known as an intelligent personal assistant. Virtual assistants are able to interpret human speech. At the time this application was filed, a number of Virtual assistants were available on the market.

### Visible Machine Readable Codes

In another embodiment, when a user sees a visible, machine readable indicia, the user is directed to use a scanning device to scan the indicia.

In a further embodiment, the scanning device is part of a wearable article, including but not limited to gloves or a ring.

In a further embodiment, the scanning device is a mobile device running an L-Book application.

### Invisible Machine Readable Indicia

There is a benefit to using invisible machine readable indicia, such as QR codes. Invisible machine readable indicia are not seen by the user and the user does not have to take any action. Thus a user's normal reading routine is not modified.

In another embodiment, a clip-on sensor automatically scans the non-visual indicia without user intervention.

In a further embodiment, the clip-on sensor is part of a clip-on reading light.

In another embodiment, the clip-on sensor is designed to attach to reading glasses.

### Other Methods

In another embodiment, a 3-axis sensor and a weight sensor is embedded in the printed book cover or the removable book jacket. Thus the current invention could determine what page a reader is on.

In another embodiment, metallic ink is printed on specific positions on the printed book pages and a metal detecting sensor is embedded in the book cover or the removable book jacket. Thus the current invention could determine what page a user is reading

In another embodiment, magnetic ink is printed on specific positions on the printed book pages and a magnetic detecting sensor is embedding in the book cover or the removable book jacket. Thus the current invention could determine what page a user is reading.

In another embodiment, a device with eye tracking functionality, such as smart glasses is used to precisely determine what page and where on a page a user is reading.

c. Determine What Pre-Determined Content is to be Played at Pre-Determined Areas of a Book

In another embodiment, the pre-determined content is a “Play List”. This may be on a music streaming platform such as Spotify.

Content may include, but is not limited to, audio, lighting, smell, temperature, air currents, motion, and haptic effects; alone or in any combination. In general, audio content may include music, environmental effects, such as haunted house noises, special effects, such as thunder and spoken text. In general, lighting may include environmental light, such as, dim flickering lights suggesting candlelight, special effects, such as lightning, and video, such as a video of a log burning in a fireplace.

In a further embodiment, a database is created and maintained containing what content is to be played at pre-determined areas of a book.

In another embodiment, content may additionally include taste. For example, upon seeing a specific indicium, a user may be directed to eat or drink a specific food or drink. For example, a plurality of crackers with a plurality of different tastes may be individually wrapped and marked to be eaten when specific codes are seen by a user. Another example would be a user's 3D Food printer may be directed by the L-Book to print specific food to eat when specific codes are seen by a user. 3D Food printing refers to the additive manufacture of food, created by squeezing out food, layer by layer, into three-dimensional objects. At the time this application was filed, there were a plurality of commercial 3D food printers available on the market.

d. Determine What Devices a User Desires the L-Book System to Use

A user may desire to use a subset of available playback devices to play content, depending upon the user's current location or mood. Additionally the user may want to modify intensity of some or all of the content.

In another embodiment, a digital user interface allows a user to determine what electronic devices are desired.

In a further embodiment, the digital user interface is an application that runs on a mobile device.

e. Activate One or More Playback Devices to Play the Pre-Determined Content

The preferred embodiment includes an L-Book application running on a device, such as a mobile device which communicates with one or more Playback Devices.

In another embodiment the communication is through wireless technology such as Bluetooth.

### Electronic Books

In another embodiment, a dedicated electronic book (e-book) reader displays visual indicia positioned in a predetermined location in an e-book.

In a further embodiment, a dedicated electronic book reader application sends book identification and the page identification from the page that a user is reading to a second application.

Other technical advantages will be readily apparent to one skilled in the art from the following figures, descriptions and claims. Moreover, while specific advantages have been enumerated above, various embodiments may include all, some, or none of the enumerated advantages.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 depicts a block diagram of one embodiment of the current invention

FIG. 2 depicts a block diagram of one embodiment of the L-Book application of the current invention.

FIG. 3 depicts the logic flow of one embodiment of the current invention.

### DETAILED DESCRIPTION

Embodiments of an L-Book can be implemented in a variety of ways. The following descriptions are of illustrative embodiments, and constitute examples of features in those illustrative embodiments, though other embodiments are not limited to the particular illustrative features described.

For ease of discussion, the L-Book will be taught illustrating L-Book benefits for printed graphic novels. One knowledgeable in the art would recognize that the current invention has benefits for all printed books, comic books and electronic books.

### Definitions

The following definitions are used in the detailed discussion.

Content. Content may include, but is not limited to, audio, lighting, smell, temperature, air currents, and haptic effects; alone or in any combination. In general, content is considered files meant for playback and/or a set of directions for a device. For example, content may be an audio file. In another example, content may be a set of directions for a device such as a fan; in this case content may be activating the fan at 50% percent power, then turning the fan off after 15 seconds.

Play Content. When discussing playing content, it is assumed that a specific device will activate a specific sequence for a specific time. For example, a digital device may be directed to play a specific audio clip for 10 seconds. In another example, a fan may be directed to turn on for 15 seconds.

Book Jacket. When discussing a book jacket for an L-Book, it is assumed that the book jacket is a detachable cover for a printed book constructed in a manner that holds the book jacket to the printed book and is constructed in a manner to hold logic and circuitry.

Visual Indicium. In some embodiments, visual code refers to a machine readable code, such as a QR code, which requires a user action when seen. In other embodiments, visual code refers to a non-machine readable indicium, which requires a user action when seen.

First Device. For ease of discussion, a first device refers to the logic and circuitry required to identify where in a printed book a user is reading, and communicate that information to a second device. A first device may additionally comprise logic and circuitry to determine a book identification and communication that information to a second device.

Second Device. For ease of discussion, a second device refers to logic and circuitry that can communicate with a first device, run an application, and communicate with a one or more devices that can play content. A second device is typically a device a user already owns, such as a mobile device. One knowledgeable in the art would understand that the First Device and Second Device may be physically separated or contained in the same physical device. Furthermore, one knowledgeable in the art would understand that in different embodiments, some functionality may be associated with device one and in others may be associated with device two. A second device may additional contain logic and circuitry to determine a book identification.

Book identification. A unique identifier for a book, such as an ISBN number.

Switch. For ease of discussion, a switch is considered a specific action performed by a user and recognized by the L-Book system. This may include, but is not limited to, pushing a button, “swiping” in a specific manner on a mobile device or speaking a specific word or phrase. One knowledge in the art would understand that there are a plurality of methods to recognize a specific action performed by a user.

For example a switch may refer to a button. Pressing the button once may indicate a first switch has been activated. Pressing the button twice within two seconds may indicate a second switch has been activated. A switch may be physical or virtual.

Indicia, plural noun, (singular, indicium) is an indication or token. For ease of discussion, indicia refers to a printed: mark, code, token, or indication, that signifies to the L-Book system that content may be available to play. This may include an area of a page printed with magnetic or metallic ink.

Panel. A panel is an individual frame, or single drawing, in the multiple-panel sequence of a comic book. A panel consists of a single drawing depicting a frozen moment.

### Overview

A new type of book, referred to as a “Living Book” or “L-Book” has been invented. In the primary embodiment the L-Book system is designed to provide an Environmental Immersion Experience while reading a printed book. More specifically, the L-Book is directed at means to identify where in a printed book a user is reading. When a user is reading a pre-determined location in the printed book, means to play pre-determined content on one or more devices, wherein the pre-determined content may include, but is not limited to, audio, lighting, smell, temperature, air currents, motion, and haptic effects; alone or in any combination.

More specifically, the preferred embodiment of the current invention is directed toward printed indicia in a printed book and towards printed logic and circuitry to:

a. determine what printed book a user is reading,

b. determine approximately where in a printed book a user is reading,

c. determine what pre-determined content is to be played at pre-determined areas of a printed book,

d. determine what devices a user desires the L-Book to use,

e. activate one or more Playback devices to play the pre-determined content.

a. Determine What Book a User is Reading

In general, content is synchronized to what a user is reading. For example, if a user is reading a story set in an urban setting, content may include ambient traffic noises. If a user is reading a story set in a haunted house, content may include ambient haunted house audio such as creaking doors, moans and unexplained noises. The L-Book system is designed to enhance a user's experience through playing specific content at specific times throughout a book. Thus each L-Book may have a unique set of content.

In one embodiment, a user may identify the current book by using an L-Book application playing in a second device. This includes, but is not limited to, typing a book identification (ID) into the L-Book application, using the second device as a scanner to scan a machine readable code on the printed L-Book, or choosing a book identification from a drop-down menu.

In another embodiment the first device may include a scanner which scans a machine readable code on the printed L-Book.

In another embodiment an active tag such as a Radio-frequency identification (RFID) tag is embedded in the printed book and either the first or second device includes means of reading the RFID tag.

There is an advantage to the L-Book system requiring as little user intervention as possible. The goal of the current invention is to enhance the printed graphic novel reading experience by providing an Environmental Immersion Experience, thus there is a benefit in having as much of the L-Book process automated so that a user is not required to change their normal reading routine.

b. Determine Approximately where in a Printed Book a User is Reading

A plurality of different methods to determine where in the printed book a user is reading are taught by, but not limited to the following embodiments. Each embodiment differs in price point, accuracy, and ease of use.

### Indicia Overview

In one embodiment a visual indicia indicating user action is desired, is positioned in a book at locations where content is to be played. There is a benefit to having the visual indicia be themed to the printed book being read. For example, in a printed graphic novel about a haunted house, a red skeleton associated with a graphic panel may indicate user action is desired.

In another embodiment the indicia are machine readable codes, such as QR. In a further embodiment, these machine readable indicia are printed in a color not visible to the human eye such as Ultra-Violet “UV” or Infra Red “IR”.

### Visual Indicia

In one embodiment when a user sees a visual indicium while reading a book, the user is directed to take an action thereby notifying the L-Book system that an indicium has been seen. When receiving this input, the L-Book system plays pre-determined content. It is important that the user action is as easy to perform as possible. One knowledgeable in the art would recognize this action could be a user picking up a mobile device then typing into the mobile device a page number and code number. Actions like these disrupt the typical user reading experience. An improvement would be an action that does not require a user to put down the printed book.

In one embodiment, the user may be directed toward activating a switch in the cover of a printed book. In effect this is a “next” function. That is, the L-Book system keeps in memory the previous time, if any, the switch has been activated. Upon user activation, the next pre-determined content is played.

In a further embodiment the switch may be in a removable cover, or book jacket. Thus the cover could be used for multiple different books, potentially reducing the cost to a customer. In this embodiment, the switch and associated logic and circuitry constitutes Device One. In addition, Device One has a means to communicate with a second device. One knowledgeable in the art would understand that there is a plurality of methods to communicate from Device One to Device Two. The preferred embodiment would be a short distance wireless technology such as Bluetooth.

In further embodiments, Device One may be independent from the printed book. For example, if Device Two was a mobile device such as a mobile phone, the mobile phone could run an application to emulate Device One. However, using a mobile phone as Device One may be awkward for a user and interrupt their reading routine. There is a benefit to having a method for a user to activate a switch as unobtrusively as possible. The less a user has to change her reading routine, the more likely the L-Book will be commercially accepted. For this reason, in a further embodiment, the switch may be in a bookmark, which may have a greater commercial acceptance then using a mobile phone.

In another embodiment, the switch may be in wearable clothes, including, but not limited to, a sweater, slippers, a wristband or a tie. In a further embodiment, the switch may be in eyeglasses.

In a further embodiment, a virtual assistant is used as Device One. In this embodiment, upon seeing an indicium, the user is directed toward making a sound that the virtual assistant can recognize. Making a sound may make a user uncomfortable, therefore presenting a potential user with various L-Book configurations may be a benefit.

### Visible Machine Readable Indicia

There may be a benefit in printing machine readable visual indicia in a printed book. In this embodiment, the visual indicia is a machine readable indicia, such as a QR code, and Device

One is logic and circuitry designed to read the visible machine readable indicia and communicate with a second device. In this embodiment, a user would use Device One to scan the indicia.

In one embodiment, the user would be directed to scan an indicia containing book identification information.

In an additional embodiment, a user would be directed to scan the machine readable indicia. In one embodiment, this scan is similar to activating a “next” switch above. In some cases L-Books may be shared, such as a public library or a commercial L-Book/coffee house reading room. In the case of shared L-Books, the machine readable indicia may correlate with a unique set of playback content. The advantage of this embodiment is that the L-Book system does not have to know what book is being read, or what user is currently reading the book. The disadvantage of this embodiment is that it may be more expensive to produce than other embodiments.

In a preferred embodiment, the scanning device is in wearable clothing, including, but not limited to, gloves or a ring. In a less expensive, but harder to use embodiment, the scanning device is a mobile device running an L-Book scanning application.

### Invisible Machine Readable Indicia

There is a benefit to using invisible machine readable indicia, such as QR codes. Invisible machine readable indicia are not seen by the user and the user does not have to take any action. Thus a user's normal reading routine is not modified.

In a preferred embodiment, a clip-on sensor automatically scans the non-visual indicia on the printed book without user intervention. One knowledgeable in the art would understand that there are a plurality of methods to position a scanner to read a machine readable indicia in a book. A clip-on sensor removes the problem of having the book at an angle so a sensor can read it. In a further embodiment, the clip-on sensor is part of a clip-on reading light. In another embodiment, the scanner is part of a clip-on to reading glasses.

In another embodiment, the scanner is in “smart glasses.” A disadvantage to this embodiment is that smart glasses are expensive.

Other Methods to Determine What Page a User is Reading without Printed Indicia

In another embodiment, a 3-axis tilt sensor and a weight sensor and associated logic and circuitry is embedded in the book cover or the removable book jacket. Thus the L-Book system could determine what page a reader is on. In this embodiment, the weight sensor is able to measure the weight of the pages on one side of an open book. The 3-axis sensor allows the logic to modify the weight measured by the orientation of the book to determine the current page.

In another embodiment, metallic or magnetic ink indicia are printed on specific positions of the printed book pages and a metal detecting sensor and associated logic and circuitry is embedded in the book cover or the removable book jacket. Thus this embodiment can determine what page a reader is on. In this embodiment, the metal sensor is sensitive enough to detect the amount of metal ink on one side of an open book and thus determine what page is open. The sensor is not sensitive enough to detect the metallic ink on the other side of the book.

In a further embodiment, a device with eye tracking functionality, such as smart glasses is used along with the scanner to precisely synchronize where a user is reading with content to be played. One knowledgeable in the art would recognize that there are a number of methods to accomplish this. In one embodiment the smart glasses can read the page number of the printed book and the eye tracking functionality can be used to know exactly where on a page a user is reading. For example, if the user were reading a graphic novel, the logic and circuitry of the L-Book system would correlate the page number and eye tracking functionality with a specific panel in the graphic novel. Thus reading and content playback can be precisely correlated. For example, if panel one depicts a haunted woods during a lighting storm, visual and audio effects simulating lightning may be played. If panel two depicts a haunted house, spooky environmental audio may be played, and flickering light effects simulating candlelight may simultaneously be played.

c. Determine What Pre-Determined Content is to be Played at Pre-Determined Areas of a Printed Book

In a simple embodiment, the pre-determined content is a “Play List”. This may be on a music streaming platform such as Spotify. In this simple embodiment, different mood music may be played depending where in the book a user is reading.

Content may include, but is not limited to, audio, visual, lighting, smell, temperature, air currents, motion, and haptic effects; alone or in any combination. In general, audio content may include music, environmental effects, such as haunted house noises, special effects, such as thunder, and spoken text. In general, lighting may include environmental light, such as, dim flickering lights suggesting candlelight and special effects, such as lightning. Additionally, lighting may include images on a video device, such as a video of wood burning in a fireplace. One knowledgeable in the art would recognize that there are a plurality of devices which may play content. For example, at the time of filing, a personal scent synthesizer that can play smells was commercially available. A fan with heating/cooling functionality could be used to play air current and temperature. Haptic feedback is capable of reproducing a wide variety of vibrations for natural and lifelike haptic effects.

Haptic feedback may additionally include interactive adult wellness products also known as adult “toys.” Inventors anticipate these haptic products will be desirable for readers of L-Book Graphic Romance Novels.

The key is that these playback devices are controllable by a second device, such as a mobile phone running a L-Book application.

In a preferred embodiment, a database is created and maintained containing what content is to be played at pre-determined areas of a printed book. This database may also include information as to what order content is to be played and the duration of play. Content to be played may consist of digital files to be played on a playback device and/or may consist of a set of instructions to be followed on a playback device.

### Content Playback

The following Content Playback embodiments are meant to illustrate, but not limit, the current invention. For ease of discussion only, the following content playback embodiments will be discussed using an embodiment of the L-Book that has visual printed indicia in a printed graphic novel and a Switch One which a user activates upon seeing a visual printed code.

### Simple Playback

In a simple content playback embodiment, upon activation of Switch One, content playback begins and continues until a second activation of Switch One. The second activation of Switch One may additionally activate new content playback.

### Complex Playback

In a complex playback embodiment, content may be played as in the simple playback above. Additionally content may be associated with a delayed start time, intensity and playback duration. For example, upon activating Switch One the following may occur: environmental audio plays until a second activation of Switch One; an audio effect (thunder) plays after a ten second delay and lasts for two seconds; a lighting effect (lightning) plays after an 8 second delay and lasts for one second; and a breeze plays intermittently until a second activation of Switch One.

### Reading Test

A more environmentally immersive experience can be created by synchronizing content playback to a particular user's reading speed. In one embodiment, the L-Book system directs a user to take a reading speed test. The goal of this test would be to get an average speed a user reads one panel. Thus, if a user takes ten seconds to read one panel and the content creators want a particular playback to last for three panels, that playback content would be set to a 30 second duration. Thus when a user activates the first switch, content playback can be synchronized over a number of panels.

One knowledgeable in the art would understand that there are a numerous methods to administer a reading speed test. A preferred embodiment would be to have additional printed graphic panels for a user to read for a speed test. These additional panels may be previews of additional printed graphic novels. In this embodiment a user inputs the name of the graphic novel into the second device and the user additionally selects reading speed test. The user is directed to activate Switch One at the beginning of reading and activate Switch One a second time when the user is done reading the additional panels. A user's average speed of reading a panel can then be calculated and used to modify a complex content playback embodiment.

L-Book System with Heart Rate Monitor

In another embodiment the L-Book system additionally includes a Heart Rate monitor that is worn by the user and means for the Heart Rate monitor to communicate the user's heart rate to the second device. The L-Book application running on the second device may modify what content is to be played and content playback attributes such as, but not limited to, duration and intensity. For example, when a user is reading a graphic novel panel depicting a haunted forest, the L-Book creator may desire the user's heart rate to be slightly higher than their resting heart rate. After the user activates Switch One to indicate she is reading the haunted forest panel, audio and visual content effects of a lightning bolt and thunder are played. If the user's heart rate does not increase, additional effects may be played at a higher intensity. In a similar fashion, it may be desired that a user's heart rate go down. In this case, soothing smell content may be played and soothing environmental audio. If the user's heart rate does not go down, the intensity and duration of these effects may be increased.

One knowledgeable in the art would know that in a similar fashion, information from an EKG data device, such as from the Motiv smart ring or the Withing smart watch, may be used to modify content playback.

### L-Book Content Creation Application

Another embodiment is directed at a content creation application. This application would allow users access to a library of content suitable for L-Books and means to use their own content. One knowledgeable in the art would understand how to build a content creation application. There are two key features of the L-Book content creation application. One, it enables a graphic novel author an easy method to create a database of playable content which is correlated with an L-Book. Two, it formats/encodes this database in a manner so that only the L-Book system can use it.

Voiceover keyed to Graphic Novel Panel

In another embodiment, audio of some or all of the text on a graphic novel being read is recorded to be used as playback content. Spoken content may be used occasionally to augment the L-Book experience. Some users may prefer to hear the graphic novel being read. Often, text is incorporated into the artwork of a graphic novel, making creating and printing graphic novels in multiple languages expensive. Providing spoken text in multiple languages, with the graphic novel provided only in one language, would reduce the cost to the end user. Additionally this embodiment may be useful to a user who desires to learn the language of the printed graphic novel. In this embodiment a user would be directed to activate Switch One when a user is reading a printed graphic novel panel with text. In one embodiment a user would activate a switch when reading a new panel.

One knowledgeable in the art would understand that verbalizing is an audio effect and thus possible in the simple or complex embodiments above, but that voiceover keyed to a graphic novel is a special case.

d. Determine What Devices a User Desires the l-Book to Use

A user may desire to use different playback devices depending upon where the user is or the user's mood. Additionally the user may want to modify the intensity of the content, such as audio volume.

In another embodiment, a digital user interface allows a user to determine what playback devices are desired to be used. A user may desire to use a subset of available content at any given time.

In a further embodiment, the digital user interface is an application that runs on a mobile device. A user may desire preset lists for which playback devices to use, such as a living room, bedroom and traveling play lists.

e. Activate the Devices to Play the Pre-Determined Content.

In general, Device One of the L-Book system gathers information necessary to determine whether content should be played. One knowledgeable in the art would understand that in some embodiments above, this determination is determined by Device One and the need to play content is passed to Device Two, while in other embodiments information is passed to Device Two where the logic on Device Two makes the determination if content is to be played. The L-Book application on the second device stores or has access to what content is to be played and activates the appropriate devices remotely, such as by using Bluetooth technology. How to create an application such as an L-Book application as described is known in the art.

### L-Book System Overview

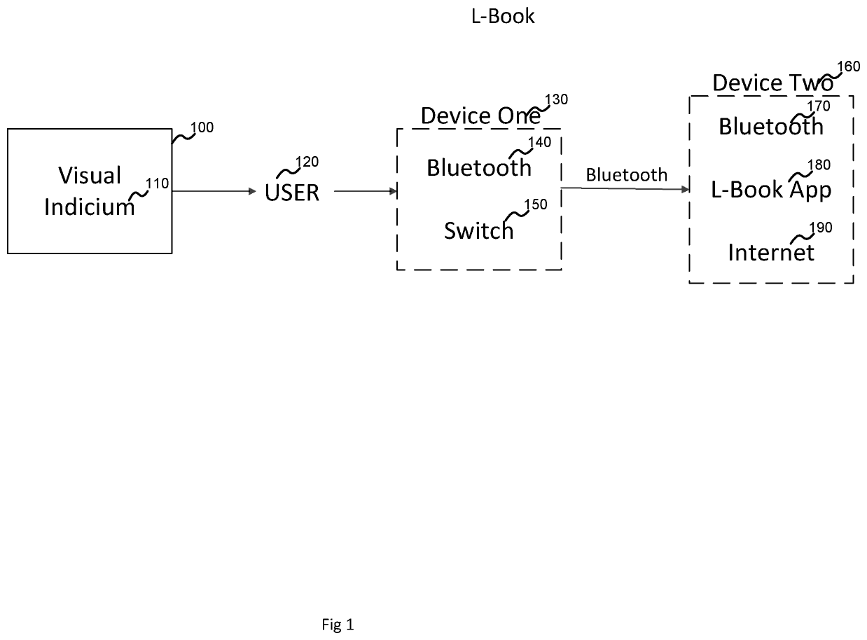

Please refer to FIG. 1. In a preferred embodiment Device One 130 is logic and circuitry configured to allow a user to activate a switch 150 and logic and circuitry to communicate with Bluetooth 140 to the Device Two 160. Device Two 160 contains logic and circuitry to: communicate with Bluetooth 170, to communicate to the Internet 190, and run an L-Book application 180.

In a preferred embodiment a user 120 sees a visual indicium 110 in a book 100. The user 120 then activates a switch 150 in device One 130. Device One 130 informs a L-Book Application 180 running on Device Two 160 of switch 150 activation over Bluetooth 140.

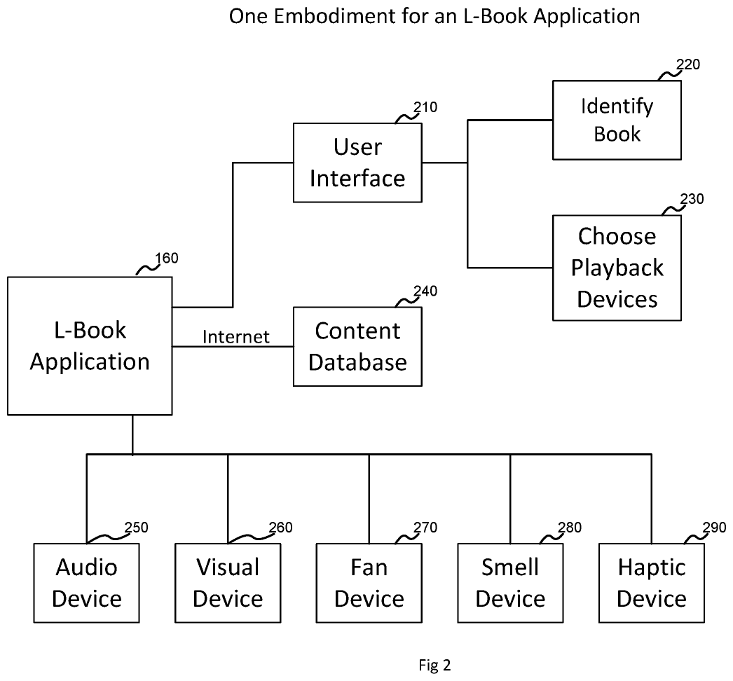

Please refer to FIG. 2. In a preferred embodiment, before an L-Book System reading sessions starts, a user 120 interacts with the user interface 210 to input book identification 220 and to choose what playback devices 230 to use for the current reading session. When an L-Book Application 160 receives notification of a switch 150 activation by a user 120, the L-Book application queries a content data base 240 through the Internet 190. The query returns predetermined content associated with visual indicium 110. The L-Book Application 160 communicates through Bluetooth 170 to predetermined output devices, which may include: an audio device 250, a visual device 260, a fan device 270, a smell device 280 and/or a haptic device 290.

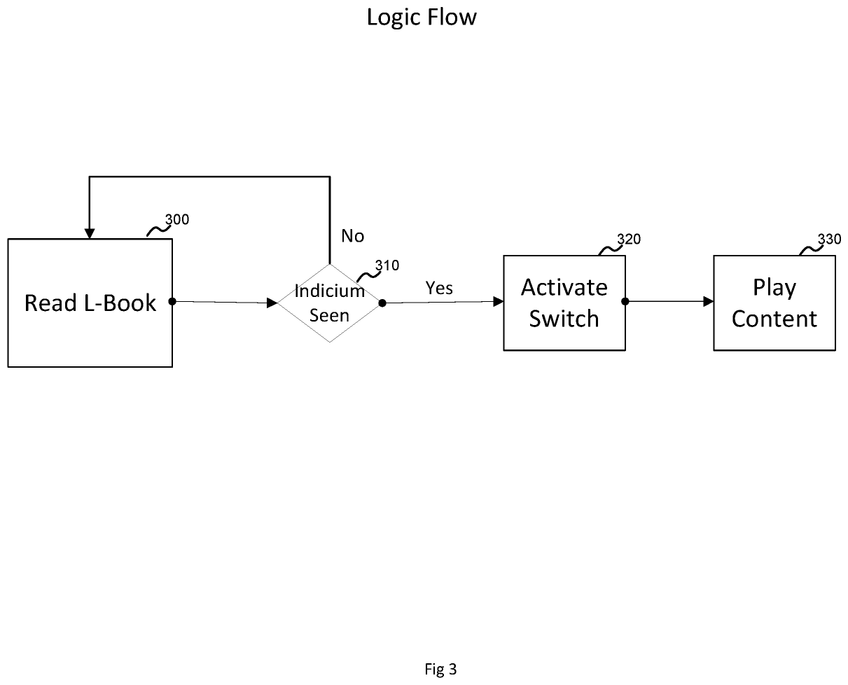

Please refer to FIG. 3. When a user is reading an L-Book 300 and sees an Indicium 310, the user activates a switch 320 and predetermined content is played on predetermined playback devices 330.

### EMBODIMENTS

### Embodiment 1: A Simple Embodiment

A simple embodiment of the L-Book system is described to illustrate, but not limit, the current invention. In one simple embodiment, a printed graphic novel is printed with visible indicia and is bound with a hardcover binding. Logic and circuitry hereinafter referred to as Device One, is contained within the binding. The logic and circuitry contains a switch for user input and means to send a signal to a second device. This signal may be a Bluetooth signal. The second device may be a mobile device running an L-Book application that is connected to the internet. When a user sees a visible indicia associated with a graphic panel the user is reading, the user activates the switch, indicating additional content is to be played.

The L-Book system stores in memory the number of times Switch One has been activated. This number is correlated with a database of content to be played upon switch activation. Upon Device One notifying the second device that the user has activated Switch One, the second device causes predetermined playback devices to play content. For example, the second device could cause a “playlist” on a music streaming device such as Spotify, to be played on desktop speakers.

In a further embodiment, a user may activate a second switch to reset the memory of which content has been played to its initial state. This embodiment would allow a second user to enjoy the L-Book from the start.

In this embodiment, the second device may be a mobile device. An L-Book application is run on the mobile device. The application includes a user interface, which presents the user a list of connected devices that are suitable for playing L-Book content. The user selects devices from this list for the user's current reading session. Upon a user activating the first switch, preselected content is played on predetermined playback devices. The content may be played concurrently or sequentially in any combination.

This is a very easy to use embodiment. A user reads a L-Book. When a user sees a visual indicium associated with a graphic novel panel the user is reading, the user activates a switch, causing audio and/or other content to be played. The audio may be, but is not limited to, environmental audio, music, and/or special effects audio.

A key feature is that the first switch is very easy for a user to activate, allowing the user to remain immersed in her book.

### Embodiment 2: “Book Jacket”

The simple embodiment described above has logic and circuitry contained within a hard cover binding. A hard cover book is more expensive than a soft cover book. The logic and circuitry in the above embodiment also increases the cost of a printed graphic novel. The Simple Embodiment with a Book Jacket is directed at a soft cover printed book with a book jacket. The book jacket is designed to be usable for any compatible soft cover L-Book and to be moved to a plurality of soft cover L-Books at a user's discretion.

In the Simple Embodiment above, the identity of what printed book is being read may be stored in the logic and circuitry when the book is manufactured. The Simple Embodiment with a Book Jacket is designed to be compatible with a number of printed graphic novels, thus there needs to be a method to determine what book is being read. In one embodiment, the softcover L-Book would have a machine readable code in a specific location printed on the outside of the cover. In this embodiment the Book Jacket has a scanner in position to read the machine readable code.

In this Simple Embodiment with a Book Jacket, the logic and circuitry correlates the identity of a printed graphic novel with the number of times a user has activated the first switch. One knowledgeable in the art would understand that this information could be stored in Device One, Device Two or on another device on the internet. This allows a user to use a plurality of printed graphic novels.

A further embodiment would additionally correlate an identification of a user with the identity of a printed novel and the number of times a user with a particular identification has activated the first switch. This allows multiple users to read an L-Book, with appropriate content being played for each user.

In a further embodiment the book jacket is a virtual assistant connected device, such as an Alexa connected device.

### Embodiment 3: User Worn Switch(es)

In this Embodiment, the switch, and logic and circuitry to support the switch of Device One is located in user worn clothes. Thus, the switch is completely independent of the printed book. The user worn clothes may include, but are not limited to, a wristband, a sweater, a blanket, a watchband, and eyeglasses. Identifying the current book being read can be accomplished by a number of means. In one embodiment, the scanner of Embodiment 2 is incorporated into the user worn clothes. In a further embodiment, the printed graphic novel has an electronic tag, such as RFID with book identification, on or in the printed graphic novel's softcover jacket, and the user worn clothing has additional logic and circuitry to read the tag. In a further embodiment Device Two has means for a user to input the book identification. In a further embodiment Device Two has means to scan the book identification code or means to read the RFID tag.

In light of the above embodiments, one knowledgeable in the art would understand that Device One may be located in a variety of devices a user might have near her when reading, including, but not limited to, a bookmark, a clip-on light, and a writing device.

### Embodiment 4: A Mobile Device has all or a Subset of the Functionality of Device One

One knowledgeable in the art would understand that a subset of the functionality of Device One may be located in an application run on a mobile device. In this embodiment, the mobile device would have means to determine a book identification, such as using the mobile device's camera with associated logic to read a QR code. Or, an L-Book application running on the mobile device may offer a user a means to input the book identification.

In a further embodiment, a mobile device has the functionality of Device One and Device Two. A user may activate a switch by swiping in an L-Book application running on a mobile device. One knowledgeable in the art would understand that there is a plurality of ways for a user to operate a switch in this embodiment. Additionally, in this embodiment, the mobile device may be used to scan a machine readable indicium. One disadvantage of this embodiment is the need for the user to hold a printed book and operate a mobile device at the same time. The current invention is directed at ease of use so that a user can enjoy a printed book with minimum disruption.

### Embodiment 5: Virtual Assistant

In this embodiment, the visual indicia is a printed phrase which a user is meant to verbalize to a Virtual Assistant. Thus, in this embodiment, the functionality of Device One is replaced by the Virtual Assistant. For example: speaking “Alexa, P33A” would identify the first indicium on page 33. The Virtual Assistant, upon receiving the spoken indicium, communicates with an L-Book application running on a device connected to both the Virtual Assistant and devices used to play content. The L-Book application then plays content as in Embodiment 1.

In another embodiment, the visual indicia may indicate a user make a noise, verbally or with another device, such as a clicker.

In this embodiment the user interface may be audio. Thus the user could identify the current book being read by verbalizing, and additionally verbalize what playback devices are to be used.

The advantage of this Embodiment is that a user does not have to purchase a Device One. The disadvantage is that a user may be uncomfortable verbalizing commands and/or not have a Virtual Assistant.

### Embodiment 6: Embodiment with Visual Machine Readable Indicia

In another embodiment when a user sees visible machine readable indicia, the user is directed to use a scanning device to scan the indicia. In this embodiment, device one would include logic and circuitry to support a scanning device and a means to communicate with a second device. In this embodiment, the scanning device will communicate with an L-Book application running on a second device. In this embodiment, Device One may be in wearable clothes, including but not limited to a ring or gloves.

One knowledgeable in the art would recognize that a mobile device, such as a phone, could be used as Device One to scan the machine readable indicia with an appropriate application.

### Embodiment 7: Embodiment with Non Visual Machine Readable Indicia

There is a benefit to using invisible machine readable indicia, such as QR codes. Invisible machine readable indicia are not seen by the user and the user does not have to take any action. Thus a user's normal reading routine is not modified.

In this embodiment, a fixed position scanner scans a pre-determined area of a printed book page for a non-visual indicium. In general, this means the L-Book system may identify what page a user is on when a page is turned and logic in Device Two identifies if any content is to be played on a predetermined page. In another embodiment, the scanner reads a code such as QR, with the QR code containing information about what content is to be played.

In general, Embodiment 7 is able to identify what page a user is reading. However, some content may be desired to be played at a predetermined delay after a new page has been identified. In this embodiment, what content is to be played would additionally include information on the time delay, if any, between recognizing a page turn and playing content.

One knowledgeable in the art would recognize that there are many methods to position a non-visual machine code sensor. These may include, but are not limited to, a clip-on book sensor, a sensor as part of a clip-on book light, a camera and a clip-on glasses sensor.

### Embodiment 8: Weight Sensor

In another embodiment a 3-axis tilt sensor and a weight sensor is embedded in the book cover or the removable book jacket. With printed pages of a known weight, logic and circuitry with a weight sensor can determine what page of a printed book is currently opened. However the weight of the open pages on a weight sensor may change the further the book is held from a horizontal position. With the addition of a 3-axis tilt sensor and supporting logic and circuitry, a more accurate determination of the current page is possible.

In this embodiment the first device is logic and circuitry supporting a 3-axis tilt sensor and weight sensor and means to communicate with a second device. An application on the second device will determine what content is to be played depending upon what page number a user is reading. As in Embodiment 7, what content to be played will be correlated with what delay, if any, it should be played.

### Embodiment 9: Metallic or Magnetic Ink

According to Protective Technologies Int'l, “Some Metal Detectors Can Actually Detect Paper Money” by Brandon Allred: “Studies were conducted with handheld metal detectors at the University of Washington . . . the researchers were able to determine how many [U.S. currency] bills were in each stack.” In this embodiment metallic ink is printed on a specific position on each page of printed book. A metal detecting sensor and associated logic and circuitry is embedded in the book cover or the removable book jacket. Thus the current invention could determine what page a reader is on and communicate that information to a second device as in

### Embodiment 8. One Knowledgeable in the Art would Understand that Similar Techniques Using Magnetic Ink and Sensors would Work in a Similar Manner

One disadvantage of Embodiment 7, 8 and 9 is that only the page number of a book a user is reading is known. Thus, synchronizing playing content with what the user is reading can only be approximated.

### Embodiment 10: Eye Tracking

In another embodiment, a user wears a device with eye tracking functionality, such as smart glasses with eye tracking. For ease of discussion, in this embodiment the smart glasses are considered the first device. In this embodiment, the L-Book application would determine the position of the printed book relative to the smart glasses and determine where the user was looking at in the book. Thus the L-Book can precisely synchronize what a user is reading with the content to be played. In this embodiment, printed codes are not used. Rather than having content to be played being correlated with codes, content to be played is correlated with eye position on a particular page. In this embodiment, the smart glasses may read the page number of the printed book.

This embodiment allows precise synchronization between exactly what a user is reading and content to be played. This is also one of the more expensive embodiments.

### Embodiment 11: E-Book Reader without Wireless Connectivity

A dedicated e-book reader is a mobile electronic device that is designed primarily for the purpose of reading e-books and digital periodicals. Typically, these devices do not have the means to communicate with playback devices, or the means to run an application to determine what content to play on the playback devices. Thus, E-Book Readers without wireless connectivity cannot communicate with an L-Book application on a second device and identify to the application what page a user is reading. In another embodiment, visual indicia are displayed by an e-book reader. A user may activate a switch, or scan the indicium when encountered. This embodiment is substantially similar to embodiment 1 or embodiment 6 above. In this embodiment an e-book reader may experience the environmental immersion advantages of the L-Book system.

### Embodiment 12: A E-Book Reader with Wireless Connectivity

A dedicated e-book reader is a mobile electronic device that is designed primarily for the purpose of reading e-books and digital periodicals. Typically these devices do not have the means to communicate with playback devices, or the means to run an application to determine what content to play on the playback devices. However, e-books with wireless connectivity have the ability to communicate what book and where in the book a user is reading to an additional application typically owned and operated by a company that brings the e-book reader to market. One knowledgeable in the art would understand that the owner of such an application may allow access to this information to an L-Book device.

In this embodiment, the e-book reader application would communicate what book and page it is displaying to a user to an L-Book application. The L-Book application would then direct predetermined content to be played on predetermined playback devices, based on the book and page that a user is reading. In this embodiment, an e-book reader may experience the environmental immersion advantages of the L-Book system.

### Example of a User Reading a Printed Graphic Novel with Embodiment 2

A user, Audrey, desires to read a printed graphic novel L-Book. The subject matter of the graphic novel is a haunted house. Audrey places a soft cover L-Book into an L-Book jacket. List one is for her living room, and this list includes, audio, visual, smell and haptic. List two is for her bedroom, and this list includes: audio and visual only. Audrey is going to read her L-Book in her living room so she chooses preset number one on her second device. Audrey uses her mobile phone as her second device. Audrey enters the identification of the graphic novel into the second device.

Audrey is now ready to sit in her favorite chair and enjoy her L-Book. On page 3, Audrey sees a Visual Indicium which is associated with a panel of a haunted forest. Audrey activates Switch One. Device One communicates Audrey's action to Device Two. Device Two determines what content is to be played on a first activation of Switch One. In this case, Device Two directs the smell device to play a forest smell for ten seconds. Additionally after a five second delay the light device is directed to play a bright flash. Lastly the audio device is to play a thunder clap one second after the light device plays a bright flash.

Further on page 3, Audrey sees a Visual Indicium which is associated with a panel depicting the interior of a haunted house. Again, Audrey activates Switch One. Device Two determines what content is to be played on a second activation of Switch One. In this case, Device Two directs the smell device to play a wood burning in fireplace smell for 5 seconds. Additionally, Device Two directs the visual device to play low intensity flickering light, simulating candlelight until Switch One is activated for a third time or 60 seconds has elapsed. Thirdly, Device Two directs the audio device to play low intensity haunted house environmental audio, such as creaking, moaning, and wind blowing for a similar period of time as the visual device. Lastly, Device Two directs the haptic device to activate, simulating a touch on the arm or shoulder for 3 seconds at a random time between 5 and 20 seconds after the second activation of Switch One.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of enhancing a reading experience of a printed book for a user, comprising:
a. determining what book a user is reading,
b. determining where in the book the user is reading,
c. determining which playback device or devices the user desires to use,
d. activating the playback devices the user desires to use when a user is reading a predetermined area of the printed book,
whereby an environmentally immersive experience is created for the user.

2. A system for enhancing a printed book comprising,
a. a printed book with one or more printed visible indicium,
b. one or more playback devices,
c. content to be played on a playback device,
d. a database containing, predetermined content to be played correlated with a predetermined visual indicium,
e. a first means, to identify what printed book is being read,
f. a second means, for the user to identify what playback devices are desired to be utilized,
g. a third means, for the user to indicate when the user sees a visual indicium,
h. a fourth means, to play the predetermined content when the predetermined visual indicium is indicated by the user,
whereby an environmentally immersive experience is created for the user.

3. The system for enhancing a printed book of claim 2, wherein the first means, to identify what printed book is being read, comprises: a machine readable indicium printed on the printed book indicating the book identification and logic and circuitry configured to read the machine readable indicium.

4. The system for enhancing a printed book of claim 2, wherein the first means, to identify what printed book is being read, comprises: logic and circuitry configured to accept input from a user.

5. The system for enhancing a printed book of claim 2, wherein the third means, for the user to indicate when the user sees a visual indicium, comprises: logic and circuitry configured to present a switch for the user to activate.

6. A system for enhancing a printed book comprising,
a. a printed book with one or more printed machine readable indicium,
b. one or more playback devices,
c. content to be played on a playback device,
d. a database containing predetermined content to be played correlated with a predetermined machine readable indicium,
e. a first means, to identify what printed book is being read,
f. a second means, for the user to identify what playback devices are desired to be utilized,
g. a third means, to identify an indicium near where the user is reading in the printed book,
h. a fourth means, to play the predetermined content when the predetermined machine readable indicium is scanned,
whereby an environmentally immersive experience is created for the user.

7. The system for enhancing a printed book of claim 6, wherein the third means, to identify an indicium comprises: logic and circuitry operated by the user to scan an indicium.

8. The system for enhancing a printed book of claim 6, wherein the third means to identify an indicium comprises: comprises logic and circuitry to scan an indicium without user intervention.

9. The system for enhancing a printed book of claim 6, wherein the printed machine readable indicium is printed in a color the human eye cannot see.

10. The system for enhancing a printed book of claim 6, wherein the printed machine readable indicium is printed in metallic or magnetic ink.

11. A system for enhancing a printed book comprising,
a. a printed book,
b. one or more playback devices,
c. content to be played on a playback device,
d. a database containing, predetermined content to be played correlated with a predetermined location in the book,
e. a device with eye tracking functionality, such as smart glasses
f. a first means, to identify what printed book is being read,
g. a second means, for the user to identify what playback devices are desired to be utilized,
h. a third means, to identify where the user is reading in the printed book,
i. a fourth means, to play the predetermined content when the predetermined area of the book is being read by the user,
whereby an environmentally immersive experience is created for the user.

12. A system for enhancing an electronic book comprising,
a. an electronic book,
b. an electronic book reader,
c. one or more playback devices,
d. content to be played on the playback device,
e. a database containing, predetermined content to be played correlated with a predetermined indicium,
f. a first means, to identify what printed book is being read,
g. a second means, for a user to identify what playback devices are desired to be utilized,
h. a third means, for the user to indicate where in the book the user is reading,
i. a fourth means, to play the predetermined content when the an indicium is seen,
whereby an environmentally immersive experience is created for the user.

13. A system for enhancing an electronic book of claim 11, wherein the electronic book has one or more visual indicia, displayed at predetermined positions in the book to a user.

14. A system for enhancing an electronic book of claim 12, wherein the electronic book reader has wireless connectivity with the means to transmit book identification and the current page that is displayed to a reader to a second application.
